(19) United States
(12) Patent Application Publication
(10) Pub. No.: US 2009/0080025 A1
(43) Pub. Date: Mar. 26, 2009

(54) PARALLEL PROCESSING OF PAGE DESCRIPTION LANGUAGE

(76) Inventors: Boris Aronshtam, San Carlos, CA (US); Leonid Khain, Herzliya (IL)

Correspondence Address: David A. Novais;Eastman Kodak Company, 343 State Street, Rochester, NY, 14650-2201, US

(21) Appl. No.: 11/858,477

(22) Filed: Sep. 20, 2007

(51) Int. Cl. G06K 15/00; G06F 3/12

(52) U.S. Cl. 358/1.17

(57) ABSTRACT

A method and apparatus for efficient processing a page description language (“PDL”) data stream lacking page independence is described. The method and apparatus includes applying a single parsing pass for a PDL job and detecting PDL job producers by creator sniffer (83). Shared resources in the PDL job are detected by resource sniffer (85). Page boundaries in the PDL job are detected by page data sniffer (84) and an organized representation (63) is produced without rearranging data and resources in the PDL job. The system efficiently organizes PDL stream into pages, data and resources without rearranging the stream. The organized data can be efficiently submitted to plurality of PDL processors (65).

### FIELD OF THE INVENTION

The present invention relates to methods and apparatus for efficient processing of page description language (PDL) data as required by printing systems, display systems, PDL analyses systems, and PDL conversion frameworks.

### BACKGROUND OF THE INVENTION

PostScript language is well known to a person of ordinary skill in the art. PostScript is a page description language (PDL) that contains a rich set of commands that is used to describe pages in the print job. A principal difference between PostScript and other PDLs, e.g. IPDS, PDF, PCL, PPML, is that it is a programming language. This provides power and flexibility in expressing page content, but the flexibility comes at a high price; in a general PostScript job, pages are not easy to interpret. In order to correctly interpret pages or to perform meaningful transformations on PostScript jobs, a PostScript interpreter is needed. Adobe Configurable PostScript Interpreter (CPSI) is one example of a PostScript interpreter, which processes a PostScript job and produces bitmaps. Adobe Distiller is another example of a PostScript interpreter, which processes a PostScript job and produces a PDF file, as opposed to bitmaps.

Since the inception of PostScript in 1984, engineers around the world have implemented numerous technologies in order to overcome certain known limitations of the PostScript language. Among these limitations are:
a) Speed limitations that prevent PostScript jobs to be executed at printer-rated speeds.
b) Inability to split PostScript into separate independent pages, as required for executing the pages on multiple central processing units (CPUs) in parallel.
c) Inability to efficiently print the selected pages, as required for efficient selective page-ranges reprinting.

In order to understand the specifics of the performance issues and the nature of common practices as well as the invention disclosed below, an explanation of a typical PostScript interpreter is necessary. The processing of a PostScript job consists of two (typically overlapping) stages; an interpretation-stage and an output-stage.
PostScript is an interpreting language. As with any kind of interpreter (e.g. Perl, Java), during interpretation a PostScript job is parsed, and the internal job structure is created. This internal job structure could be a linked list (or a tree) of high-level or low-level graphical objects, a complex state that describes pages in the job, or any other proprietary representation format.
During the output-stage, the internal job structure is processed, and the required output is created. In case of a printing system, pages are rendered and a raster (e.g., raw bitmap) is produced and, typically, delivered to the printer. In case of Adobe Distiller, a PDF file is produced. Other formats (e.g. AFP/IPDS) can be also produced using a similar approach.

Interpretation historically was considered a light stage, while rendering was considered a heavy stage as far as the amount of data produced. Typical source data for a PostScript page that contains text and graphics is ˜100 KB. When rendered at 600×600 dpi CMYK, a typical raw bitmap page is ˜100 MB, which is 1,000 times larger than the source data.

This is why, since the inception of the PostScript language, in order to skip rendering, engineers were using the technique of “writing to null-device.” This technique is described in all the versions of Adobe “PostScript Language Reference Manual.” According to this technique, one can skip rendering of the pages by setting a null-device and then re-establishing the real-device to resume the rendering. The null-device approach is typically augmented by redefinition of multiple PostScript operators (e.g. show, image, etc.) to further reduce the interpretation overhead. Using this null-device approach one can skip pages by interpreting the pages and skipping the rendering. Using this skip-mechanism a person of ordinary skill in the art can implement the parallel processing of pages as depicted in FIG. 1.

FIG. 1 shows four processors. In this approach each of the four processors receives the entire PostScript job 11, and each processor skips some pages and processes others. For example, the first processor 12 processes pages 1, 5, 9 . . . , while the second processor 13 will process pages 2, 6, 10 . . . , the third processor 14 will process pages 3, 7, 11 . . . , and the fourth processor 15 processes pages 4, 8, 12 . . . Obviously this trivial load-balancing algorithm can be improved to take into account the current load of processors, the complexity of pages, and other characteristics. This load-balancing consideration is applicable to all the future diagrams.

It is easy to see the gain of this approach provides. Assume that it takes a single-CPU system 100 seconds to process the entire job. Let us further assume that interpreting is four times faster than rendering, which is a fairly reasonable assumption. According to these assumptions the interpretation takes 20 seconds, while rendering takes 80 seconds. Coming back to FIG. 1, each processor spends the same 20 seconds for interpreting (each processor needs to interpret the entire job), but only 20 seconds for rendering (each processor needs to render only a quarter of the pages). In this case the entire job is processed in 40 seconds. This achieves 2.5× performance gain (100/4=2.5).

FIG. 2 shows eight processors. Processing is split between interpretation and rendering using separate processors. Interpreters 22 send interpreted PostScript stream to renderers 26, thus achieving the pipeline parallelism (in addition to the above page parallelism). Using the above numbers and considering that the interpretation and the rendering stages are pipelined (run in parallel) the entire job is processed in approximately 20 seconds. This achieves 5× performance gain (100/20=5).

The method shown in FIG. 2 is completely adequate in cases where the interpretation time is insignificant compared to rendering time as was in the early printing days. But the interpretation/rendering balance has significantly changed since 1984 because of the following factors:
a) To speed up the performance, companies have significantly invested in rendering technologies by providing extremely efficient rendering systems and proprietary hardware solutions.
b) Multi-CPU systems became much cheaper. The latest trend in mainstream CPU technology is that a general CPU now contains multiple processing cores which behave as independent CPUs. One can expect 8-core, 16-core, and 32-core CPUs in the near future.
c) Many more jobs nowadays contain very complicated graphics and large images that require heavy interpretation.
d) Printing speeds have drastically increased, and are measured over 100 and even 1000 ppm (pages per minute).

As the result of the factors described above, the rendering to null-device, wherein each processor interprets the entire PostScript job, becomes inadequate for achieving high engine speeds. In other words, interpretation, as an inherently sequential process, becomes a bottleneck of the printing system. For example, adding extra processors to the FIG. 2 diagram will not increase the performance, since each interpreter will need to spend the same 20 seconds to interpret the job.

Realizing that the multiple interpreters in FIG. 2 duplicate each job, a person of ordinary skill in the art can isolate the interpretation and move it to a separate processor as shown in FIG. 3. In this diagram the centralized interpreting processor 32 interprets the job PostScript 11 and produces some internal job structure (display-list), which contains independent pages 33. The display-lists of independent pages 33 are sent to individual rendering processors 34. The main advantage of this approach compared to the approach described in FIG. 2, is that only five CPUs are required to achieve the same performance. Moreover, using a more powerful CPU for the centralized interpreter processor 32 the interpreting bottleneck can be somewhat reduced.

A serious disadvantage of this approach is its complexity, separating a PostScript processor into an independent interpreter and renderer running on separate nodes is a complex procedure. It requires significant code changes and requires the source code to perform the changes. The main drawback of this approach though is that the interpreter is still a bottleneck. Using the numbers suggested in the examples above, increasing the number of rendering processors 34 will not increase the performance.

In view of foregoing, it would be desirable to provide methods and apparatus that remove the interpreter as a bottleneck, thus increasing the total speed of the system. It further would be desirable to provide methods and apparatus that will not require modifications in the interpreter.

A known variation on the centralized interpretation approach is the PDF approach as shown in FIG. 4. In this approach, a PostScript (PS) job 11 is converted to PDF by PS to PDF converter 42. The created PDF 43 is distributed by the PDF distributor 44 to the multiple processors 45. There are numerous utilities available to convert PostScript to PDF. Adobe Distiller is probably the most known one.

There are also numerous approaches for distributing the PDF Job 43 to the processors 45:
a) The entire PDF file can be sent to all the processors. Each processor is told which pages to render.
b) The PDF job can be converted to a series of single-page PDF files. These single-page PDF files can be sent to the processors, thus each processor receives only the required PDF pages to render.
c) PDF can be converted to a series of single page PostScript files. These single-page PostScript files can be sent to the processors, thus each processor receives only the required PostScript pages to render.
d) Instead of single PDF or PostScript pages, page chunks can be produced and distributed to required processors, thus reducing a potential resource overhead of single pages. As a variation, the entire job can be split into a number of parts equal to a number of processors (four parts in our example).

These PDF approaches are viable processes and are known in the industry. At the same time they have the same major drawback as the “centralized interpretation” approach discussed above; since PS-PDF converter is a PostScript interpreter, the converter becomes a bottleneck. Furthermore, conversion to PDF is known to add additional significant overhead to the converter, thus creating an even bigger bottleneck. This bottleneck prevents scaling the system by adding additional processors.

Coming back to FIG. 4, instead of converting PostScript to PDF, other conversions are possible. For example, PostScript to PostScript, PostScript to AFP, or PostScript to XPS. But since all such converters are instances of a PostScript interpreter, they all have the same major drawbacks as the “centralized interpretation” approach and as the “PDF approach” discussed above; the converter becomes a bottleneck, thus preventing scaling the system by adding additional processors.

In view of foregoing, it would be desirable to provide methods and apparatus that remove the interpreter as a bottleneck, thus increasing the total speed of the system. Furthermore, it would be desirable to provide methods and apparatus that avoid the conversion from PostScript to PDF or other languages.

Realizing the issues related to unstructured nature of PostScript jobs, Adobe published “Adobe Document Structuring Conventions Specification Version 1” (DSC Specifications) as early as 1986. The best known DSC Specification Version-3.0 was published in 1992. There is a separate section in the specification named: “Parallel Printing.” This shows that the page parallel printing is one of the intentions of the DSC compliant PostScript jobs.

DSC specification defines a set of tags that allows easy parsing of PS resources, and rearranging the pages. Moreover, it mandates that if a producer outputs “%!PS-Adobe-3.0” it guarantees that this PostScript file is DSC compliant. Unfortunately, the reality is such that almost all the major PostScript producers insert “%!PS-Adobe-3.0”, while these files are rarely DSC compliant.

Nevertheless, as the practice shows, one can successfully split a large set of PostScript jobs into independent pages by parsing for DSC comments and for producer-specific patterns. Though this process is rather complex, multiple companies have successfully used this approach since 1988. For example, a number of companies such as Creo (Preps®) and Farukh, used this approach for performing imposition, which is a significantly more complex process than achieving parallel printing. Not only were these companies able to transform PostScript generated by multiple major vendors into page-independent PostScript, they were also able to combine multiple PostScript jobs produced by different applications into one imposed PostScript job, thus achieving even higher level of page independence.

At the same time the printing system mandates different requirements than the imposition:
a) The printing system is expected to be more reliable than the PostScript imposition software. It is expected that it processes a much larger set of PostScript jobs than the imposition system and gracefully reports regarding the job it cannot process using DSC and pattern recognition method.
b) The printing system needs to be much faster than the imposition software.

In view of foregoing, it would be desirable to provide methods and apparatus that are significantly more reliable and faster than the existing DSC-based systems.

FIG. 5 shows a job-parallel approach. It addresses many complexities and inefficiencies of page-parallel approaches. In this approach multiple processors 55 process multiple PostScript jobs 51 in parallel. Since there is no inherent overhead of the separate interpretation and splitting, this approach is very efficient for a large set of short jobs; when one job is finished printing another job is processed and ready for printing. At the same time this approach is unsuitable for large jobs:
a) The first job does not benefit from multiple processors.
b) The job processors may run out of page storage and stay idle for long time, waiting for the printer to print previous jobs.

The situation is exacerbated by very long PostScript jobs, such as variable data printing (VDP) jobs expressed in Creo VPS or other PostScript dialects. One such job may contain over 100,000 pages and run for many days. In this case the job parallel approach will definitely result in utilizing only one processor, while keeping the remaining processors idle.

Returning to DSC compliance, the main issue with non DSC compliant PostScript is the lack of the job structure and the page interdependence.
a) By the lack of job structure we mean the absence of strict and easily identifiable boundaries between pages in PostScript jobs.
b) By page interdependence we mean that each page may contain hard-to-identify resources that are expected to persist beyond the page scope.

So one may ask why the PostScript producers do not move all the resources into the job header. The answer is because the job generation would require two passes, an analyses pass and an output pass.
a) During the analysis, all the pages are analyzed for the required resources.
b) During the output pass the resources are written into the job header section. Only after that the independent pages are written.

Since producing pages at high speed by applications is as important as consuming pages by printers, and considering that the page independence was not a requirement for PostScript producers in the past, it is evident why pages in PostScript jobs are interdependent.

The situation has changed somewhat with the introduction of the most modern PDL, such as PPML. PPML is an XML-based VDP language, meaning it was specifically designed for achieving high printing speeds. PPML was designed by a standard committee, PODi, which includes all the major printer-controller manufacturers as well as a number of major document producing companies. With respect to job structure, PPML solves this issue by requiring mandatory XML tags. The standard dictates that:
a) a PPML job consists of document sets
b) a document set consists of documents
c) a document consists of pages

As far as the page structure is concerned, PPML does not resolve the issue of page interdependence. As with PostScript pages, a PPML page may contain resources that are expected to persist beyond the page-scope. This was a conscious decision of all PODi members dictated by the need to output PPML pages at very high-speed, thus avoiding two passes over the data. As the result, a PPML page interleaves resources and data like:

BeginPage
data, resource, resource, data, data. . .
EndPage

The only significant difference from PostScript is that resources are easily identifiable. The understanding of PPML job structure will assist in understanding the existing patents, as well as in understanding the present invention.

The additional prior art in this field includes:
1. Agfa, U.S. Pat. No. 5,652,711 (Vennekens).
2. Electronics For Imaging, WO 04/110759 application.
3. Xerox, U.S. Pat. No. 6,817,791 (Klassen).

U.S. Pat. No. 5,652,711 is a broad patent, applicable to all PDLs, including PostScript. The patent describes methods for parallel processing a PDL data stream. It considers a PDL data stream that defines a print job as a combination of data commands and control commands. Data commands describe the data that must be reproduced by the output device, such as text, graphics and images, whereas control commands describe how the data must be reproduced, and may include font descriptions, page sections, forms and overlays. Each produced independent data stream segment includes data commands to describe the images included in a single page or region, and also includes control commands to instruct how the data commands must be interpreted.

PDL data stream is submitted to a master process, which divides the PDL data stream into independent data stream segments that are converted to intermediate data stream portions by multiple sub-processes. To achieve the segment independence each segment must know “translation state” for the segment, which is composed of all previous control commands.

The method requires the complete knowledge of the PDL stream, which can only be achieved by interpreting the stream. Realizing that the interpretation is a bottleneck, one of the embodiments of the invention distributes this interpretation onto multiple sub-processes. Any sub-process that encounter a change in translation state reports this change to the master process. Special techniques are used to synchronize the state created by multiple sub-processes.

Apart from the complexity of the invention described in U.S. Pat. No. 5,652,711, the patent does not disclose the mechanism for creating the segments. For example, in case of PostScript, there is no notion of “data commands” and “control commands.” Nearly all graphics operators change the state of the interpreter. Unfortunately, the patent does not provide mapping from PostScript operators to data/control commands.

WO 04/110759 is also a broad patent, applicable to all PDLs, including PostScript. The goal here is to overcome page-interdependence. As with many other known techniques, each page is split into segments. What is novel here is that each produced segment is represented by two new files: a global data file and a segment data file. In order to skip a page the global file need to be executed. In order to print a page a segment data file need to be executed.

Unfortunately, WO 04/110759 does not disclose the mechanism for identifying the segments. Nor does the patent describe the mechanisms for creating global data files and segment data files that constitute the segments. From the description of the patent, considering that the invention is capable of recognizing and to extracting “graphics objects,” and considering that there were no references to DSC and DSC-related patents, one may assume that an interpreter-based approach is implied, thus, as discussed above, limiting the total throughput of the system.

U.S. Pat. No. 6,817,791 describes splitting a PostScript job into independent pages. The PostScript job is analyzed for resources (idioms, according to the language of the patent); then the resources are extracted and are rearranged in the header of the print job. The header is then prefixed to each page, thus making it contain all the necessary resources, thus making it independent of other pages. Each header (that is attached to a page) contains all the resources preceding the page, but does not include the resources of the page.

As acknowledged by the patent, this results in large headers attached to the pages. To circumvent the problem, U.S. Pat. No. 6,817,791 introduces the notion of the “chunk”; instead of splitting a job into independent pages the job is split into independent chunks. In this approach the header overhead is amortized by a number of pages in the chunk. The chunk could be as small as one page or as large as the entire job. Since the chunks are independent, they can be processed in any order and can be distributed to multiple processing nodes for parallel processing, thus calling it chunk-parallelism.

Regarding chunk-parallelism, it is unclear how this chunk-parallelism is different from other well-known chunk-parallelism approaches. For example, “Adobe Document Structuring Conventions Specification Version 3,” published as early as 1992 mentions chunk-parallelism:
“For example, a user requests that the first 100 pages of a document be printed in parallel on five separate printers. The document manager splits the document into five sections of 20 pages each, replicating the original prolog and document setup for each section.”
   Furthermore, the patent suggests an optimized approach for the reverse printing of non-DSC-compliant jobs.
“A somewhat more efficient approach would be to make a single pass through the document finding material that should have been in the header but was not, and appending it to the header, and then putting out the header only once, followed by all of the pages in reverse order.”
   A person of ordinary skill in the art knows that the described approach will rarely work. This is because each page may contain “setfont” and other PostScript operators that propagate from previous pages and cannot be specified in the “header.” Unfortunately the non-optimized approach cannot be used because of the serious efficiency reasons related to adding the header to each page. In conclusion, it is unclear how to implement efficient reverse printing using the patent.

The main issue with U.S. Pat. No. 6,817,791, however, is the overhead of prefixing resource headers to each page. This overhead would result in suboptimal performance of the textual processing approach that uses page-parallelism. The alternative chunk-approach would result in either suboptimal load balancing (if the chunks are too large), to large header overhead (if the chunks are too small), and the need of inventing complex schemes to estimate the optimal chunk-size according to page-complexity, job-size, resources in the system, current system load, and other factors.

In view of foregoing, it would be desirable to provide a method and apparatus that would:
1. Avoid accumulated header overhead,
2. Use page-parallelism, thus avoiding the aforementioned chunk-size estimation complexities,
3. Achieve an efficient range-printing, and
4. Achieve a reliable page-reversal.
   The subject invention overcomes the problems specified above, as well as others.

### SUMMARY OF THE INVENTION

The invention provides a method and apparatus for efficient processing of a PDL data stream (job) lacking page independence. The system efficiently organizes a job into pages, data and resources. The organized job has the following benefits:
1. The organized job provides a high-level structure of the original job. This structure is instrumental for job analyses, reporting, preflight, imposition decision, and other processing.
2. The organized job can be submitted to multiple PDL processors for efficient page-parallel processing.
3. Selective pages or page ranges can be efficiently printed.
4. Pages can be efficiently rearranged for achieving page-reversed printing and other sequences.
   The organized job has the following properties:
1. The organized job does not rearrange data and resources of the original job.
2. The organized job can be efficiently packaged using multiple formats to satisfy workflow, storage, performance, and other needs.
3. The most efficient packaging can be achieved by representing an organized job as a separate external structure, similar to a directory that points to the segments of the original PostScript job using pointers or offsets, thus preserving the original job and avoiding overhead of writing a modified job.
   In case of PostScript jobs, the invention uses DSC processing and textual parsing.

### BRIEF DESCRIPTION OF THE DRAWINGS

FIG. 1 is a schematic illustrating parallel processing of pages using null-device.

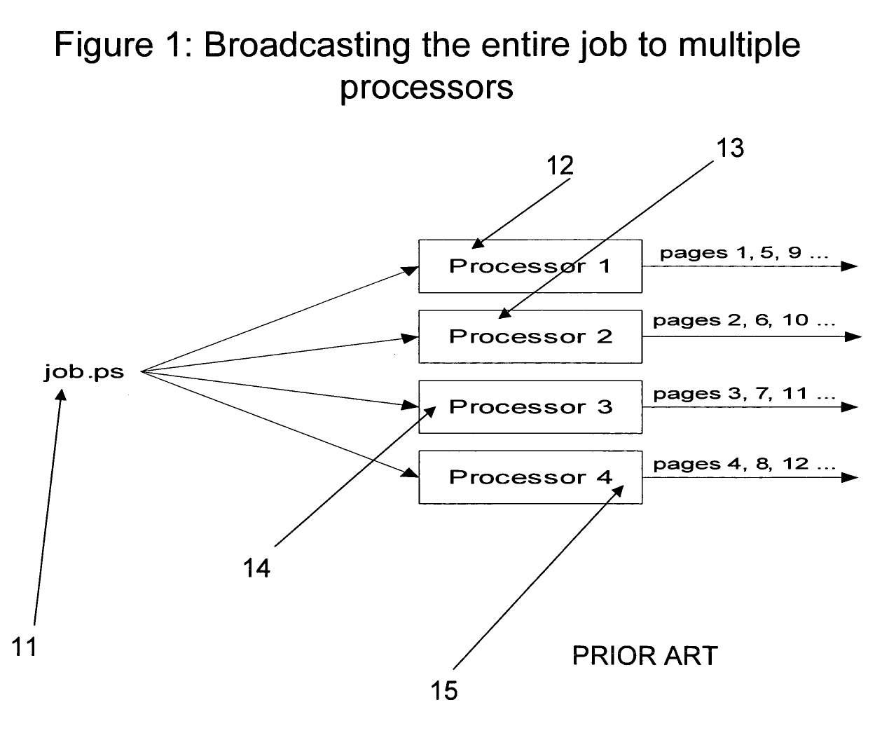

FIG. 2 is a schematic illustrating two-stage pipelined parallel processing of pages using null-device.

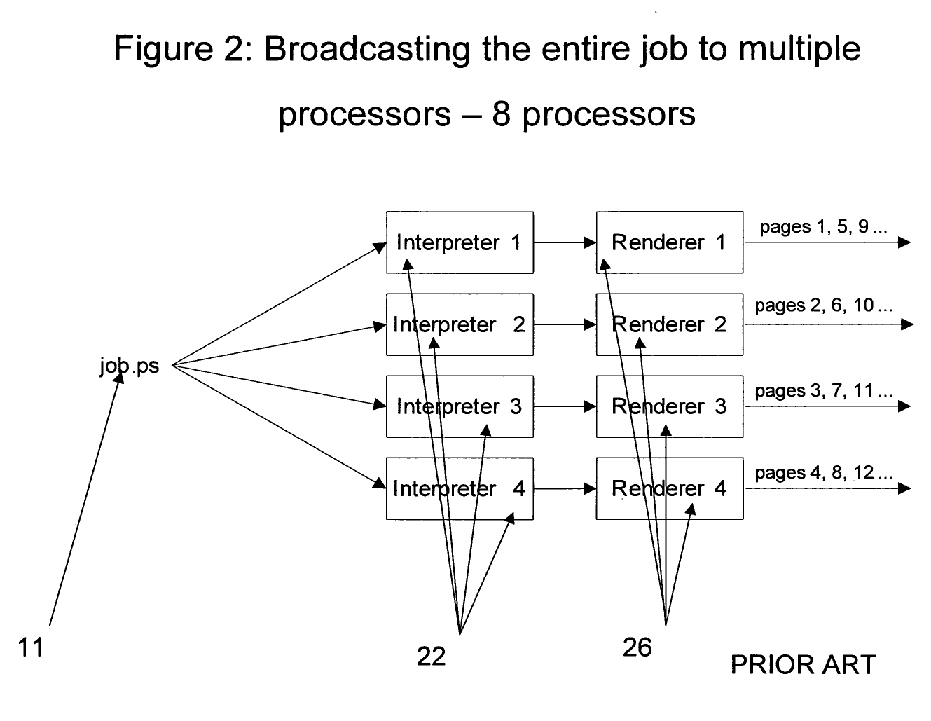

FIG. 3 is a schematic illustrating display-list based centralized interpretation.

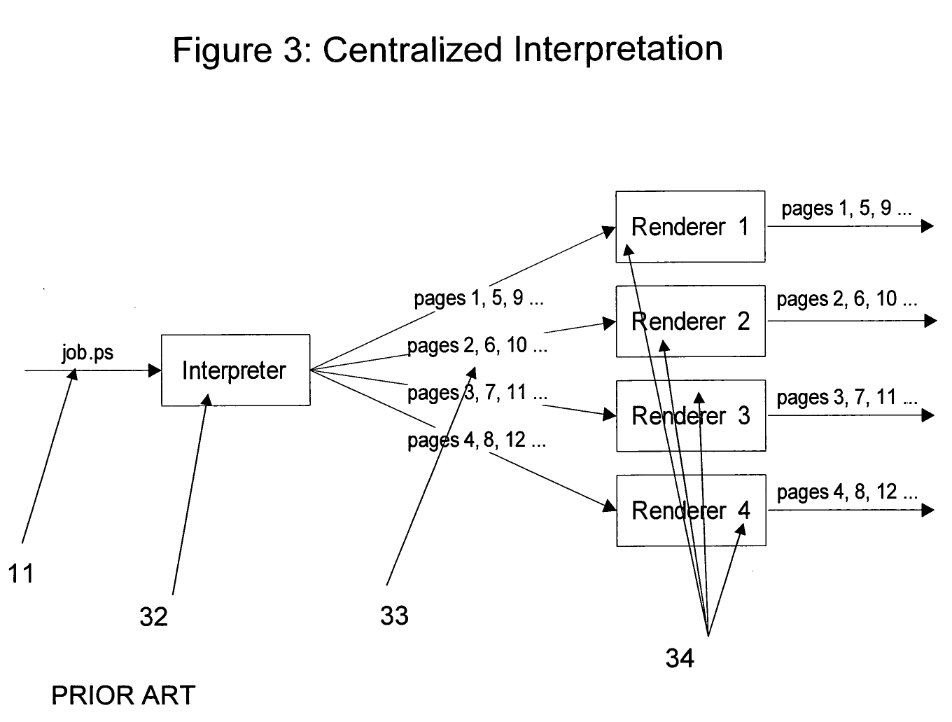

FIG. 4 is a schematic illustrating a PDF approach for page parallelism.

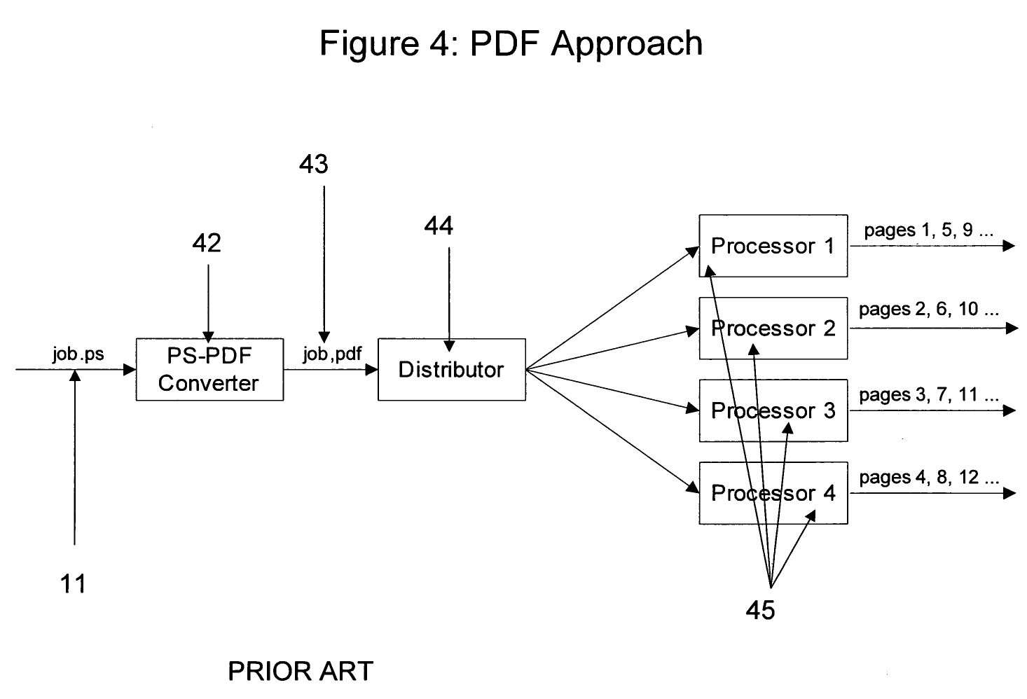

FIG. 5 is a schematic illustrating job parallel approach.

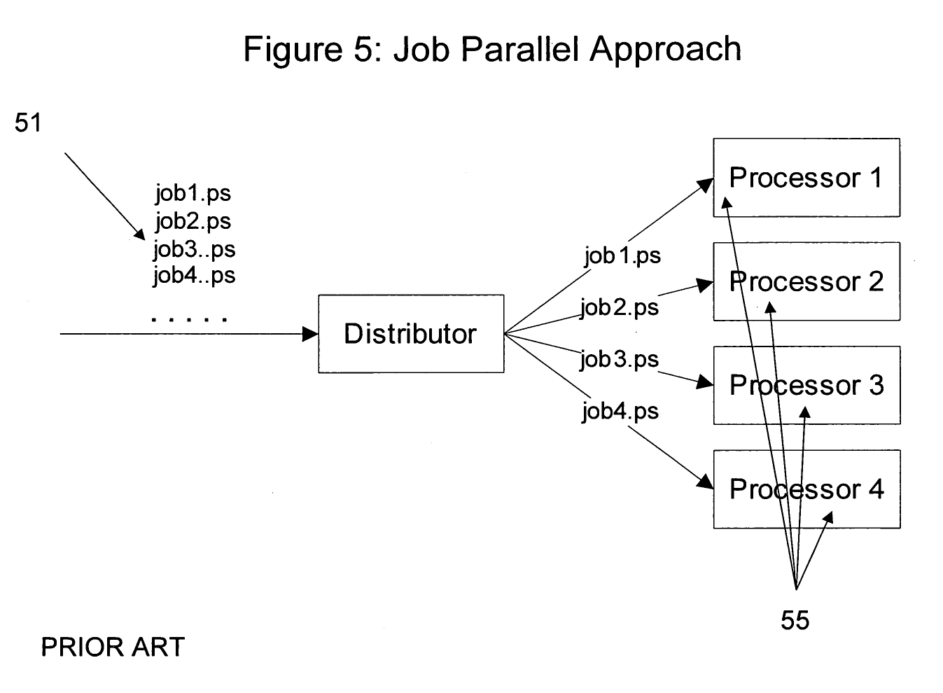

FIG. 6 is a schematic illustrating general processing diagram.

FIG. 7 is a schematic illustrating splitting resources to resource storage.

FIG. 8 is a schematic illustrating organizer components.

### DETAILED DESCRIPTION OF THE INVENTION

This detailed description of the invention will allow a person of ordinary skill in the art to implement the invention in its full expression, while not limiting the creativity of the implementers in achieving the best possible performance and the ability to handle most efficiently all of the required producers.

While the present invention is described in connection with one of the embodiments, it will be understood that it is not intended to limit the invention to this embodiment. On the contrary, it is intended to cover all alternatives, modifications and equivalents as covered by the appended claims.

Achieving highest possible speeds using multiple processors for PostScript jobs and PostScript-based VDP jobs is a complex task and there is no good “mathematical solution” to it. This is why the invention is based on some conclusions that are verified by extensive experience in the field:
1. Page-parallel printing does not require page-independence. Page-parallel printing requires only “page-separation” with explicit “resource marking.” A page-distributor needs to send either the entire page to the processor that renders this page or only resources defined on this page to the other processors that do not render this page. This is why PPML, which by design is not page independent, is ideally suitable for achieving the efficient page parallelism.
2. Short jobs can be most efficiently processed using job parallelism. The definition of the short job depends on the system: a number of processors, the printer speed, expected job complexity, etc. For some systems the short job is defined as having up to four pages, while for some other systems the short job may be defined as having up to 100 pages or even more.
3. The concentration of resources declines rapidly within a medium-size or a long-size PostScript job. That is, most of the resources are defined before the first page or within the first page. The second page typically contains fewer resources than the first page. The third page typically contains even less resources than the second page. In case where the job contains 500 pages, it is unlikely that page 250 contains any resources. For a typical PostScript-based VDP job that contains over 100,000 documents it is highly unlikely that there will be any resources beyond the first 100 documents.

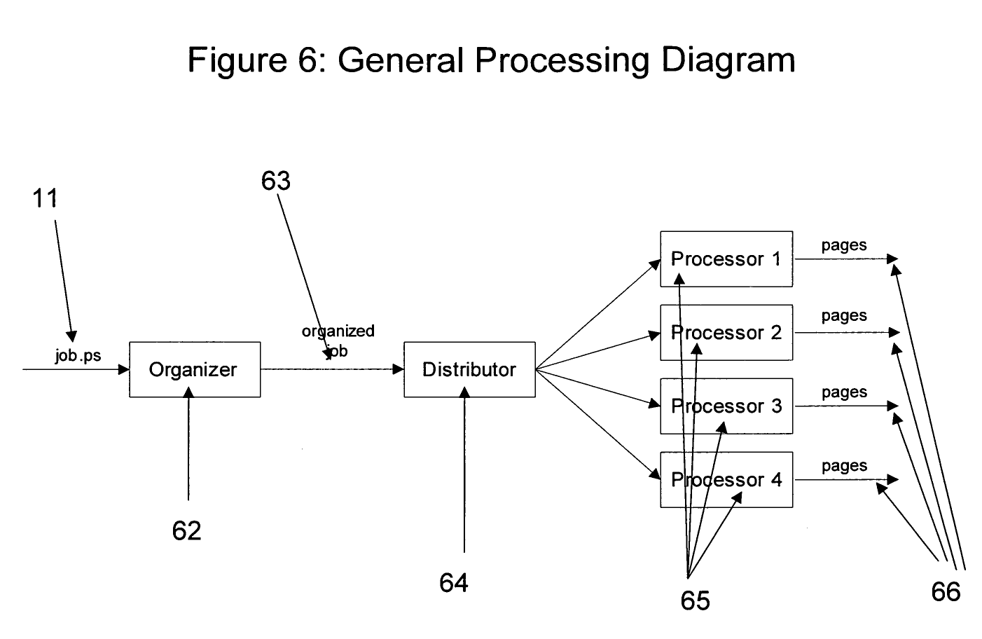

According to the above conclusions, the major goal of the invention is to organize the job by efficiently marking pages, documents and resources in the job for the efficient distribution to multiple processing nodes. Referring to FIG. 6, the component that organizes the pages is job organizer 62, which receives PostScript job 11, and produces an organized job 63. The component that distributes the organized job to the plurality of PDL processors 65 is called distributor 64.

One aspect of the invention is that the organizer does not need to rearrange the job, it may keep all the data and resources in-place. This is what distinguishes the present invention from other inventions and results in unprecedented speeds of splitting and parallel-processing. In fact, in one of the embodiments of the invention the organized job is represented as a list of references (directory) to the sections of the original job. In order to understand and to appreciate this statement consider possible organization and packaging of the organized job.

The organized job is represented as a number of consequent segments. The segments define job structure using metadata, and contain job data. Each segment is defined by a tag and the following seven tags are needed:
BeginJob
EndJob
BeginDoc
EndDoc
BeginPage
EndPage
Data
   For a pure PostScript job (that does not have a notion of docs) only these five tags are needed:
BeginJob
EndJob
BeginPage
EndPage
Data
   An example of a simple organized job that contains one document that contains two pages would include the following tag:

```
BeginJob
  Data
  BeginDoc
    BeginPage
      Data
    EndPage
    Data
    BeginPage
      Data
    EndPage
  EndDoc
EndJob
```

A formal description of an organized job is:
job=BeginJob, [doc|Data]*, EndJob
doc=BeginDoc, [page|Data]*, EndDoc
page=BeginPage, [Data]*, EndPage
   A verbal description of the above formal description is:
A job is encapsulated by BeginJob and EndJob tags and contains multiple doc and Data segments.
A doc (or a booklet in VPS terms), is encapsulated by BeginDoc and EndDoc tags and contains multiple page and data segments.
A page is encapsulated by BeginPage and EndPage tags and contains multiple Data segments.

Similar to PPML, data may contain an explicit scope. The scope can be: page, doc, job, and global. The resource is defined as data with scope higher than the current scope. For example, if data defined within a page and has job scope it is a resource. The reader will appreciate the conventional definition of the resource (identical to resource definition in PostScript, PPML, and other PDLs). The organized job is suitable for page-parallel distribution as well as for document-parallel distribution.

A distributor dispatches the organized job for page-parallel processing according to the following rules:
Data with scope=global, job, and doc is distributed to all the processors assigned for processing this job.
Data with scope=page for a given page is distributed only to one processor—the processor assigned for processing this page.
   The distributor dispatches the organized job for document-parallel processing according to the following rules:
Data with scope=global and job is distributed to all the processors assigned for processing the job.
Data with scope=doc and page for a given doc is distributed only to one processor—the processor assigned for processing this doc.
   The organized job can be packaged to satisfy the storage and performance needs of the system:
The organized job can be packaged using XML. Each segment is represented as an XML construct. This is similar to PPML (with all the known issues related to binary data).
A more efficient packaging uses tag and length format for each segment. This is similar to known formats, such as the TAR format, and allows the efficient binary representation.
Even more efficient packaging is represented as a separate external structure, similar to a directory that contains tags and points to the segments of the original PostScript job using pointers or offsets. This justifies one of the claims of the invention that in one of the embodiments of the invention the entire job is preserved. This is a unique representation that is not known in the art of PostScript job transformation and is available only as the result of this invention.

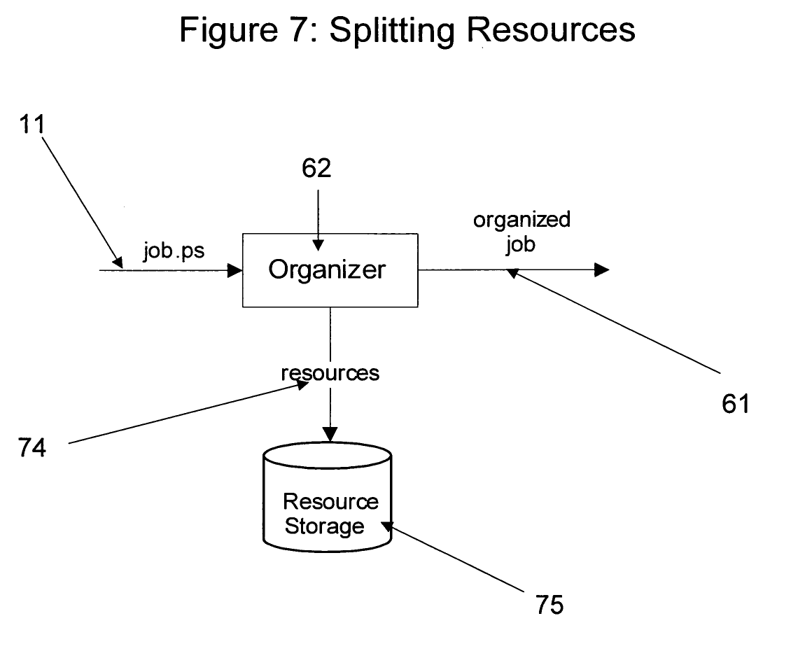

Some implementations may find it more beneficial to keep all or some of the common resources 74 residing in the shared resource storage 75, storage is shared between organizer 62, distributor 64, processors 66, as well as with other system-nodes, as it is depicted in FIG. 7.

For example, some systems may benefit from storing global VDP objects in the shared resource storage 75, while others may benefit from storing all VDP reusable objects in the shared resource storage 75, and others may benefit from storing all or some PostScript resources in the shared resource storage 75. The benefit of doing so is keeping resources in the central place and reducing the size of the organized job. Some systems may benefit from creating an organized job that removes the above stored resources from the organized job, while some may benefit from representing the organized job as an efficient external structure pointing back to the original job. In either case, it is important to understand that the invention does not rearrange data/resources of the original job when the organized representation is produced.

Some considerations regarding global-scope resources follow. Similar to PPML, the global scope is used to define and to preserve global-resources between jobs. This is the main and the conventional purpose of global scope. But in one of the embodiments of the invention, the global-scope is used for representing unprotected PostScript jobs, the jobs that change the permanent state of the PostScript interpreter. Using the distribution logic described above, each node will receive all the data (because it has global-scope). In order to neutralize the effect for ‘showpage’ operators (that otherwise may result in printing all the pages by each node) a number of well-known techniques can be used (redefining showpage, establishing null-device, and more). Presenting this embodiment of handling unprotected jobs, other approaches for handling unprotected PostScript jobs that rely on this invention are feasible.

The reader must appreciate the highly streaming nature of an organized job. That is, the segments of a page can be distributed to the processors immediately after they are marked (which most often happens even before the page is organized). Only one pass through the job is required to organize and to distribute the job.

Though a preferred embodiment of the invention does not rearrange resources in the job and keeps them where they are found, it will be understood that rearranging the resources and moving them elsewhere in the organized job or even outside the job (as shown in FIG. 7) does not change the spirit of the invention.

For example, an embodiment of the invention may move the resources from within the page where the resources were found to the front of this page (for esthetics or for other reasons). Though this likely makes the embodiment less efficient, it is still significantly more efficient than accumulating all the resources into the header and prefixing such header to each page, as done by some of the applications that seek page-independence.

Since the organized job allows efficient page skipping, the invention allows efficient page-parallel page-range processing.

Rearranging or reversing pages in the job is a more complex procedure. Other inventions in the area of parallel-page printing either do not address this issue, such as WO 04/110759, or provide a very limited solution, such as U.S. Pat. No. 6,817,791, which will fail on a significant portion of files. For the sake of the discussion let us concentrate on reversed printing, which is the worst case of page-rearrangement. The reversed printing is achieved by the following techniques:
1. Perform a complete pass to organize the job. This will mark page-boundaries and resources.
2. During the above pass collect all the producer-specific idioms that affect the graphics state that persists between pages and associate it with each page. An example of such idiom will be “fontname Ji” command produced by Windows driver. This command sets font to ‘fontname.’ Note that this is very different from collecting and accumulating resources: for example in case of Windows driver each page needs to associate just last ‘Ji’ command with a page (not all the previous ‘Ji’ commands as would be with resources). As the result, this associated state is extremely small (typically measured in hundreds of bytes or even smaller).
3. Execute all the resources. This creates appropriate PostScript Virtual Memory (VM) state.
4. Distribute pages to processing nodes in the reverse order. Before distributing page add a tiny header that sets the needed part of graphics state.
   The above approach will work for a very wide range of printing jobs.

These and other objects, features, and advantages of the present invention will become apparent to those skilled in the art upon a reading of the following detailed description when taken in conjunction with the drawings wherein there is shown and described an illustrative embodiment of the invention.

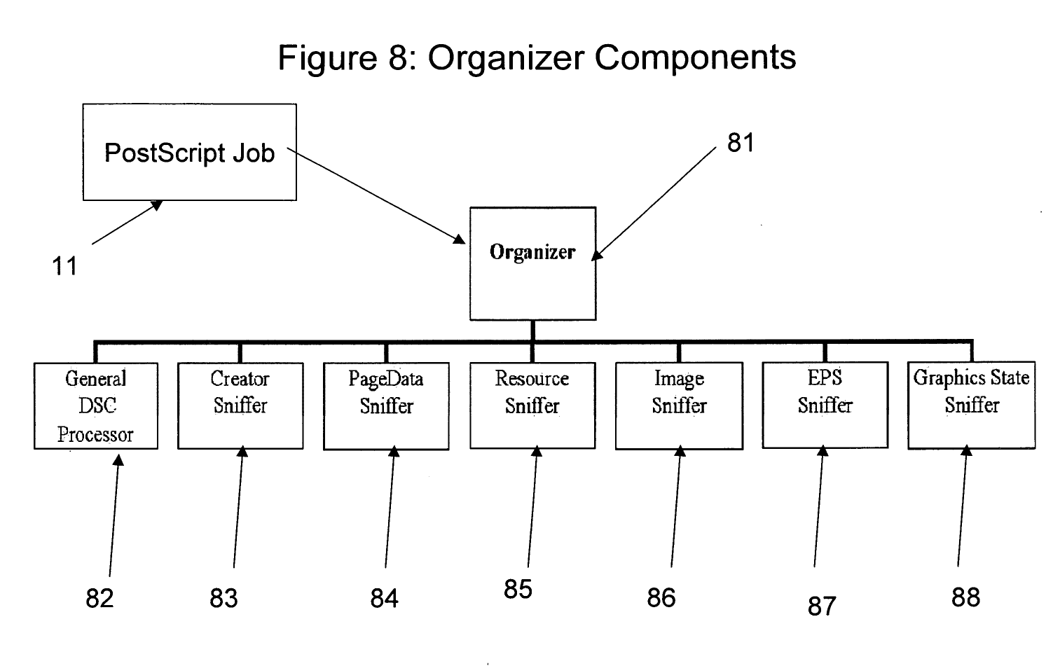

An organizer component parses the original job in a streaming fashion, analyzes it, compensates for non-DSC-compliance, and outputs well-formed organized job suitable for the efficient distribution to multiple processing nodes. To successfully organize a large number of jobs produced by a large number of different producers a preferred embodiment of the invention contains the components shown in FIG. 8. Without changing the nature of the present invention, the components can be renamed, the components responsibility can be rearranged, the components are split into multiple subcomponents, and some of the components are even removed.

Parsing can be done line-by-line, token-by-token and other granularities, but, for the convenience of the description, reference will be made to parsing by line. Each line in the original job is analyzed in a streaming fashion. If a line starts with “%%” it is a candidate for a DSC line. Some simple additional processing is sufficient to increase the chance that this is indeed a DSC line. If a line is mistakenly identified as a DSC line (for example a line within binary data may look like a valid DSC line) this is not a problem; the probability it will match any valid and expected DSC is negligible (not encountered in extensive testing). DSC lines are important, and help to perform the general DSC processing, to identify the creator of the job, to identify the structure of the job, and even sometimes to detect resources.

As mentioned above, most PostScript jobs are non-DSC-compliant. But typically each producer breaks DSC compliance in a producer-specific predictable way. This is because each producer, being a finite program, may produce only a limited number of output patterns. In order to organize a PostScript job for efficient parallel processing, an organizer needs to compensate for this non-DSC-compliance. This is done by analyzing job data. To achieve correct and efficient compensation for the non-DSC-compliance, the organizer needs to identify the producer (is also known as a “creator”).

Some explanation is needed for the word producer. Saying that the producer is XyzSoft is generally insufficient. It needs to be further clarified as XyzSoft that uses a Windows driver, or XyzSoft that uses a LaserWriter driver, or XyzSoft that uses native code generation. All of these outputs are usually very different. Sometimes one even needs to specify a version of XyzSoft and a version of Windows driver, etc. This is why the producer needs to be identified by a complete identity set that may include application name, driver name, version, etc.

This may produce a very large number of combinations. One approach to reduce this combinatorial-explosion is to leverage the fact that, in general (not always), XyzSoft patterns are the same, independently of the driver used. This is why it is advisable to have a separate set of components that analyzes separately XyzSoft patterns, Windows patterns, LaserWriter8 patterns, etc. We will call such specific components “producer-processor.” (Not to be confused with multiple processors that render the job.)

As far as the producer term, it is more precise to talk about application/driver combination. It is even better to use term producer-chain, this accommodate different cases of a native producer:
Pure driver (a number of elements in the chain is equal 1)
Native application (a number of elements in the chain is equal 1)
Application/driver combination (a number of elements in the chain is equal 2)
Some cases when a number of producers in the chain is more than 2 (e.g. Creo Darwin that uses QuarkXPress that uses LaserWriter8 driver. This creates a 3-element producer-chain).

### General Processing Flow

In a snapshot, organizer parses a PostScript job line-by-line. At the beginning the producer-chain is empty (producer is unknown). The general DSC processing 82 is used.

At some moment organizer 81 detects the first element in the producer-chain. For further discussion let us assume that it is a LaserWriter8 driver. Since that moment each line is submitted to LaserWriter8 processor (an instance of producer-processor).

LaserWriter8 processor performs a fast analysis of each line. Usually analyzing a few bytes at the beginning of the line and at the end of the line is sufficient in order to discard the lines of no interest. Most of the lines are not interesting for the producer-processor. But if the line has a potential of interest a more elaborate processing is performed. If the line is recognized as a resource-pattern by resource sniffer 85, the producer-processor invokes some producer-processor specific logic and marks the resource. This producer-processor specific logic involves searching back for the beginning of the resource and searching forward for the end of the resource. The resource is found and the processor informs organizer regarding the start-position and the end-position of the resource. The organizer marks the resource in accordance with the packaging scheme discussed above and advances its position immediately after the resource. This concludes handling of this resource.

If the producer-processor does not recognize the line it efficiently returns. The organizer then uses general DSC processor logic, described below, to handle the line.

The strength of this approach is that each producer-processor can overwrite the default behavior of general DSC processor where it is required, while at the same time to rely on power of general DSC processor to handle most of the lines. This way each producer-processor can be implemented in the minimum number of code-lines needed to compensate for the specific non-DSC compliance; a more compliant producer results in a simpler producer-processor implementation.

Continuing with the example, the organizer detects the application (the driver LaserWriter8 was detected in the previous stage). For specificity, let us say it is Adobe Acrobat. Organizer installs this as the second element in the producer-chain. Since this point organizer will offer each line to each producer-processor in the producer-chain:
Organizer will offer a line to Adobe Acrobat;
If the line is rejected organizer will offer the line to LaserWriter8;
If the line is rejected organizer will process it using general-DSC-processor.

### General-DSC-Processor

In FIG. 8, general DSC processor 82 is responsible for the general DSC processing flow as defined by the “Adobe Document Structuring Conventions Specification.”

Though one cannot rely on DSC-compliance, as one can see in the “General Processing Flow” description above, a general-DSC-processor is a very important component. It implements the default behavior of organizer and makes each producer-processor as small as possible and easy to implement. The general-DSC-processor performs operations such as analyzing job-header, analyzing job-prologue, analyzing job-defaults, analyzing resources, analyzing procsets, finding page-boundaries, finding job-trailer, and many other operations that are needed for the general DSC processing as described in “Adobe Document Structuring Conventions Specification.” In addition, it may perform other implementation-specific functions that are not strictly needed for organizing jobs for parallel-processing.

### Creator Sniffer

Creator sniffer 83 is responsible for identifying the producer-chain. As is mentioned above, it is more precise to talk not just about a single creator or a single producer, but rather about producing-chain that consists of multiple producers. Using %% Creator DSC is in general not reliable. The most reliable approach is to analyze ProcSets, special sections in a PostScript job that define PostScript procedures needed for a specific producer. As such, if the job is produced by a LaserWriter8 driver, organizer will at some point encounter LaserWriter8 ProcSets. If the job is produced by Adobe Acrobat application Organizer will at some point encounter Adobe Acrobat ProcSets. In a hypothetical example, if it is produced by XyzSoft, but there are no XyzSoft ProcSets, it simply means that XyzSoft does not use any specific XyzSoft resources in this job and, therefore, there is no need to analyze XyzSoft patterns. Considering the variety of the producers, it is still beneficial in some cases to analyze %% Creator DSC and other DSCs in determining the producer.

### Page Data Sniffer

The page data sniffer 84 is responsible for making a decision on whether to mark the entire page as a resource. Obviously, this logic is different for each producer.

As the experience shows, for example in multiple PostScript imposition packages, for a given producer one can always implement the component that detects and extracts the resources used by this producer. It is understood that often this is not simple; a significant investment of engineering time is required. For PostScript imposition applications, and for other approaches that seek page-independence there is no other viable option; the resources must be detected and extracted. This is why such applications in general use the following two approaches: 1) investing a tremendous effort to handle multiple producers; and 2) limiting the number of supported producers.

The present invention, which does not seek page-independence, has another option at its disposal. As the practice shows, it is significantly easier to recognize the presence of resources on the page than to extract or mark them. This is why the implementer of this invention may choose in some cases to make a quick pass over the page and, if the resources are found, to mark the entire page as the resource. Considering the above statement that “the concentration of resources declines rapidly within a job,” this part of the invention allows implementing a very reasonable embodiments of the invention in a very short time. Obviously, a more elaborate embodiment of the invention will use the above shortcut sparingly and will implement the resource marking for the most important producers.

### Resource Sniffer

Resource sniffer 85 is responsible for recognizing and marking the resources. The resource sniffing is described above. The implementer shall expect most of the time spent in implementing product-specific resource sniffers, unless the above shortcut of resource-pages used. Considering multiple imposition implementations, a person of ordinary skill in the art is capable to implement the resource-sniffing required to implement this invention efficiently.

### Image Sniffer

Image sniffer 86 is responsible for detecting image boundaries and skipping images efficiently. Images could be very large and it is beneficial to recognize and to skip them efficiently. Obviously, the general DSC processor 82 logic is used to skip images according to DSC conventions. This logic needs to be augmented by producer-specific pattern-recognition logic to accommodate for non-DSC compliance.

### EPS Sniffer

EPS sniffer 87 is responsible for detecting encapsulated PostScript (EPS) boundaries inside PostScript jobs and skipping EPS efficiently. Unfortunately some producers do not use DSC mechanisms for embedding EPS fragments. A failure to recognize EPS and skip EPS from resources parsing may result in incorrect parsing (e.g., producing extra pages, or marking extra resources that result in resource conflict). This is why special producer-specific pattern-recognition logic is needed to sniff for EPS.

### Graphics State Sniffer

Graphics state sniffer 88 is responsible for collecting all the producer-specific idioms that affect persistent graphics state. This producer-specific sniffer is needed to collect all the producer-specific idioms that affect the graphics state that persist between pages and associate it with each page as discussed above. An example of such idiom is “fontname Ji” command produced by Windows driver that is an alias to PostScript ‘setfont’ command that persists beyond page scope.

The invention has been described in detail with particular reference to certain preferred embodiments thereof, but it will be understood that variations and modifications can be effected within the scope of the invention.

### PARTS LIST

11 PostScript job
12 first processor
13 second processor
14 third processor
15 fourth processor
22 interpreters
26 renderers
32 centralized interpreter processor
33 independent pages
34 rendering processors
42 PostScript to PDF converter
43 PDF job
44 PDF distributor
45 multiple processors
51 multiple PostScript jobs
55 multiple processors
62 job organizer
63 organized job
64 distributor
65 plurality of PDL processors
66 processor
74 common resources
75 shared resources storage
81 organizer
82 general DSC processor
83 creator sniffer
84 page data sniffer
85 resource sniffer
86 image sniffer
87 EPS sniffer
88 graphic state sniffer

1. A method for organizing a print job described in a page description language (PDL) lacking page independence, where the organized job is not required to be page-independent and can be efficiently split and processed by plurality of processors comprising the steps of:
applying a single parsing pass to a PDL job;
detecting PDL job producers;
detecting and marking shared resources in said PDL job;
detecting and marking page boundaries in said PDL job; and
producing an organized representation according to said detecting steps of the original said PDL job without rearranging data and resources in said PDL job.

2. A method for reordering a print job described in a page description language (PDL) lacking page-independence comprising the steps of:
applying a single parsing pass to a PDL job;
detecting PDL job producers;
detecting and marking shared resources in said PDL job;
detecting and marking page boundaries in said PDL job;
recording commands that define a graphics state for each page;
producing an organized representation according to said detecting steps of the original said PDL job without rearranging data and resources in said PDL job;
executing said resources; and
prefixing graphics state commands to said pages to be sent reordered.

3. The method of claim 2 wherein reordering is page reversal.

4. The method of claim 1 wherein the PDL job is PostScript job.

5. The method of claim 1 wherein marking is done in said PDL job.

6. The method of claim 1 wherein marking is done by pointing from said organized representation into sections of the said PDL job.

7. The method of claim 1 wherein organized representation results in a small form factor.

8. An apparatus for reordering a print job described in a page description language (PDL) lacking page-independence comprising:
means for applying a single parsing pass to a PDL job;
means for detecting PDL job producers;
means for detecting and means for marking shared resources in said PDL job;
means for detecting and marking page boundaries in said PDL job;
means for recording commands that define a graphics state for each page;
means for producing an organized representation according to said detecting steps of the original said PDL job without rearranging data and resources in said PDL job;
means for executing said resources;
means for prefixing graphics state commands to said pages; and
means for sending said pages reordered.

9. The apparatus of claim 8 wherein means for reordering are means for page reversal.

10. The apparatus of claim 8 wherein the PDL job is PostScript job.

11. The apparatus of claim 8 wherein marking is done in said PDL job.

12. The apparatus of claim 8 wherein marking is done by pointing from said organized representation into sections of the said PDL job.

13. An apparatus for reordering a print job described in a page description language (PDL) lacking page-independence comprising:
a processor for applying a single parsing pass to a PDL job;
a creator sniffer for detecting PDL job producers;
a resource sniffer for detecting and for marking shared resources in said PDL job;
a data sniffer for detecting and marking page boundaries in said PDL job;
a processor for recording commands that define a graphics state for each page;
a processor for producing an organized representation according to said detecting steps of the original said PDL job without rearranging data and resources in said PDL job;
a processor for executing said resources;
a processor for prefixing graphics state commands to said pages; and
a processor for sending said pages reordered.
